(19) United States
(12) Patent Application Publication
(10) Pub. No.: US 2007/0147815 A1
(43) Pub. Date: Jun. 28, 2007

(54) Camera system, lens unit, camera body, and wireless communication adapter

(75) Inventor: Hiroshi Tanaka, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation

(21) Appl. No.: 11/583,910

(22) Filed: Oct. 20, 2006

(30) Foreign Application Priority Data
Oct. 20, 2005 (JP) 2005-306258

(51) Int. Cl. G03B 17/00

(52) U.S. Cl. 396/56; 396/541; 396/532; 348/207.1; 348/211.2

(57) ABSTRACT

A camera system includes a camera body and a lens unit attached detachably to the camera body. The camera body transmits authentication information through a communication terminal to the lens unit that is attached to the camera body. The lens unit stores the authentication information in an authentication memory. When the lens unit is detached, the camera body transmits the authentication information by wireless to the lens unit. The lens unit compares the received authentication information with one stored in the authentication memory for verification. When the authentication information is matched, the image capturing with the lens unit and the image data transmission from the lens unit to the camera body are possible.

### FIELD OF THE INVENTION

The present invention relates to a camera system including a camera body and a lens unit detachable from the camera body, and more particularly to a camera system which establishes and authenticates a combination of the camera body and the lens unit.

### BACKGROUND OF THE INVENTION

Digital cameras are widely used which converts images captured by a image sensor, such as CCD, into digital data and stores the data in recording media such as an internal memory and a memory card. The digital cameras have variations, and one of which is a lens-interchangeable type digital camera composed of a camera body and a taking lens (lens unit) attached detachably to the camera body.

With recent image sensors more and more downsized, it is suggested to place the image sensor in the lens unit of interchangeable type. This will eliminate the need for the lens unit and camera body to be connected optically. Additionally, if a drive circuit for the image sensor is also placed in the lens unit, the structure of the camera body can be relatively simple. Also, it is suggested to provide a wireless communication function with the lens-interchangeable type digital cameras to establish data communication between the lens unit and the camera body.

Japanese patent laid-open publication No. 10-117302, for example, discloses a camera system whose image capturing section and image display section are individually operable when detached from each other. A captured image is transmitted through wires from the image capturing section to the image display section when they are attached, while it is transmitted by radio, or wirelessly, when they are apart from each other. During the wireless image transmission, the image capturing section applies higher compression to the images than during the wired transmission, so that the images are transmitted optimally.

Also, U.S. Pat. No. 6,052,509 (corresponding to Japanese patent laid-open publication No. 09-261519) discloses a camera system that includes a camera section and a display and recording section both having a wireless transmitter/receiver circuit. Thereby, information such as a remaining battery power of the camera section and lens data can be checked on the display and recording section apart from the camera section.

Furthermore, U.S. Pat. No. 6,101,339 (corresponding to Japanese patent laid-open publication No. 11-298770) discloses a camera system composed of a camera body and a lens barrel which is detachable to the camera body and has an image sensor and a secondary battery. While the lens barrel is detached from the camera body, the image sensor runs on the electric power from the secondary battery, and the captured images are transmitted by wireless to the camera body. The secondary battery is charged by the camera body when the lens barrel is attached to the camera body.

However, none of the above camera systems is configured to recognize the combination of the lens unit and the camera body. The problem therefore arises that the lens unit and the camera body do not acknowledge each other when the lens unit is changed, and the wireless control of the system is precluded.

### SUMMARY OF THE INVENTION

In view of the foregoing, a primary object of the present invention is to provide a camera system which can establish a combination of a lens unit and a camera body, and authenticate the combination through wireless communication.

Another object of the present invention is to provide the lens unit, the camera body, and a wireless communication adapter used in such camera systems.

In order to achieve the above and other objects, a camera system according to the present invention is composed of a lens unit and a camera body, and includes a communication terminal, a wireless communication interface, an authentication information memory, an authentication memory, an authenticator, a detector, and a controller. The communication terminal electrically connects between the lens unit and the camera body. The wireless communication interface enables wireless communication between the lens unit and the camera body. The authentication information memory is provided in one of the lens unit and the camera body, and stores authentication information that is used for the wireless communication. The authentication memory is provided in the other one of the lens unit and the camera body, and stores the authentication information that is received through the communication terminal. The authenticator is provided in the other one of the lens unit and the camera body. For the purpose of verification, the authenticator compares the authentication information in the authentication memory with the authentication information received from the one through the wireless communication when the lens unit is detached from the camera body. The detector is provided in the camera body, and detects attachment and detachment of the lens unit. The controller controls the communication between the lens unit and the camera body. When the lens unit is attached to the camera body, the controller uses the communication terminal to transmit image data from the lens unit to the camera body and to transmit/receive control signals between the lens unit and the camera body. When the lens unit is detached from the camera body, on the other hand, the controller uses the wireless communication for both the image data transmission from the lens unit to the camera body and the control signal transmission/reception between the lens unit and the camera body. Additionally, the controller permits the image data transmission through the wireless communication after the verification by the authenticator.

When the camera body is the one with the authentication information memory, it is preferable that the authentication information includes camera body identification information that identifies the camera body and an authentication code for establishment of the wireless communication. Then the camera body identification information and the authentication code are associated with each other in the authentication memory. When the lens unit is the one with the authentication information memory, to the contrary, it is preferable that the authentication information includes lens unit identification information that identifies the lens unit and the authentication code for establishment of the wireless communication. Then, the lens unit identification information and the authentication code are associated with each other in the authentication memory. In addition, it is preferable that the authentication information further includes a unique IP address of the lens unit. Preferably, the authentication information memory and the authentication memory are both nonvolatile.

In a preferred embodiment of the present invention, the camera body is the one with the authentication information memory. Additionally, the camera body further includes a display for showing a list of the authentication information that is stored in the authentication memory, and an operation key for selecting the authentication information in the list. The selected authentication information is deleted from the authentication memory. In this case, it is preferable that the selected authentication information is also deleted from the authentication information memory. Still additionally, the camera body includes an external interface for connection with an external device, through which the authentication information in the authentication information memory and the authentication memory is changed.

The lens unit in the preferred embodiment further includes a lens unit memory previously storing lens unit identification information that identifies the lens unit and a name of the lens unit. Then, the lens unit identification information and the lens unit name are transmitted through the communication terminal to the camera body and stored in the authentication information memory. In this case, the wireless communication is initiated with the lens unit name as an ESS ID. Preferably, the lens unit identification information is a MAC address of the lens unit. The wireless communication is executed under a Bluetooth standard or a wireless LAN system. For the Bluetooth communication, a BD address of the camera body is used as the camera body identification information, and a PIN code is used as the authentication code. For the wireless LAN communication, a MAC address of the camera body is used as the camera body identification information, and a WEP key is used as the authentication code.

In another preferred embodiment of the present invention, the camera system is composed of a lens unit, the camera body, and a wireless communication adapter, and includes a communication terminal, a wireless communication interface, the authentication information memory, the authentication memory, the authenticator, the detector, and the controller. The lens unit is attached detachably to the camera body and the wireless communication adapter. The communication terminal electrically connects the lens unit to the camera body and the wireless communication adapter. The wireless communication interface enables wireless communication between the camera body and the wireless communication adapter. The lens unit has the authentication memory and the authenticator. The camera body has the authentication information memory, the detector, and the controller. Preferably, the wireless communication adapter has a recognizer that recognizes a command to the lens unit from the camera body, and a detector for detecting attachment and detachment of the lens unit.

According to the camera system of the present invention, the authentication information is stored in the authentication memory when the lens unit is attached to the camera body. This authentication information is used to verify the combination of the lens unit and the camera body while the lens unit is detached from the camera body. This allows the wireless communication between the lens unit and the camera body, and thus enables the camera body to remotely control the photography operation of the lens unit which is separated from the camera body. This also eliminates the need for attaching the lens unit to the camera body and establishing the combination every time the power of the system is turned on. Additionally, when several lens units are used, the camera body and each lens unit will acknowledge each other.

The stored authentication information is listed on a monitor screen of the camera body. By selecting it on the list, the authentication information is deleted from the authentication memory. Therefore, available capacity of the memory can be used effectively.

One of the embodiments uses the wireless communication adapter which makes wireless communication, in place of the lens unit, with the camera body. Since the wireless communication function is not required to the lens unit in this case, production cost of the lens unit can be reduced.

### BRIEF DESCRIPTION OF THE DRAWINGS

The above objects and advantages of the present invention will become more apparent from the following detailed description when read in connection with the accompanying drawings, in which:

FIG. 1 is an external view of a camera system according to the present invention and an external computer;

FIG. 2 is a block diagram of the structure of a camera body and a lens unit;

FIG. 3 is a flowchart of a pairing process of the camera body and the lens unit;

FIG. 4 is a flowchart of an authentication process between the camera body and the lens unit;

FIG. 5 is a flowchart for deleting information of the camera body from a pairing list stored in the lens unit;

FIG. 6 is an explanatory view of the pairing list on a LCD screen;

FIG. 7 is a flowchart of a name change process for the camera body and the lens unit;

FIG. 8 is an external view of a camera system according to another embodiment of the present invention;

FIG. 9A and FIG. 9B are block diagrams of a structure of the camera system according to the another embodiment of the present invention, wherein FIG. 9A illustrates a state where a lens unit is attached to a wireless communication adapter, and FIG. 9B illustrates the camera body to which this lens unit is attached detachably; and

FIG. 10 is a flowchart of command and reply processes by the wireless communication adapter.

### DETAILED DESCRIPTION OF THE PREFERRED EMBODIMENTS

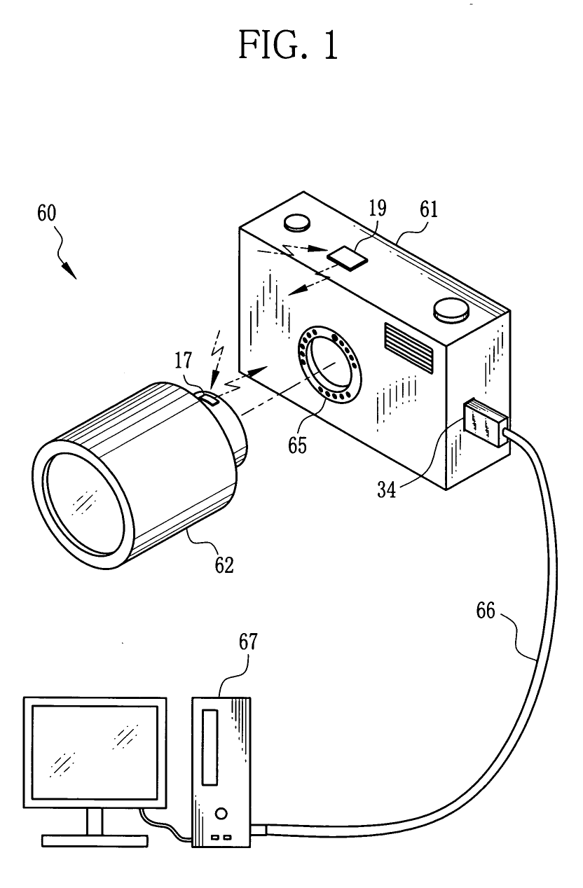

Referring to FIG. 1, a camera system 60 includes a camera body 61 and a lens unit 62. The lens unit 62 is attached detachably to the camera body 61. When attached to the camera body 61, the lens unit 62 is electrically connected to a mount 65 of the camera body 61 and communicates with it. When detached from the camera body 61, on the other hand, the lens unit 62 makes wireless communication with the camera body 61 through a lens unit antenna 17 and a camera body antenna 19. This wireless communication enables the camera body 61 to control the photography operation of the lens unit 62 remotely. A side face of the camera body 61 is equipped with a USB connector 34, which may be connected through a USB cable 66 to an external computer 67, so that names or other information of the camera body 61 and the lens unit 62 can be changed.

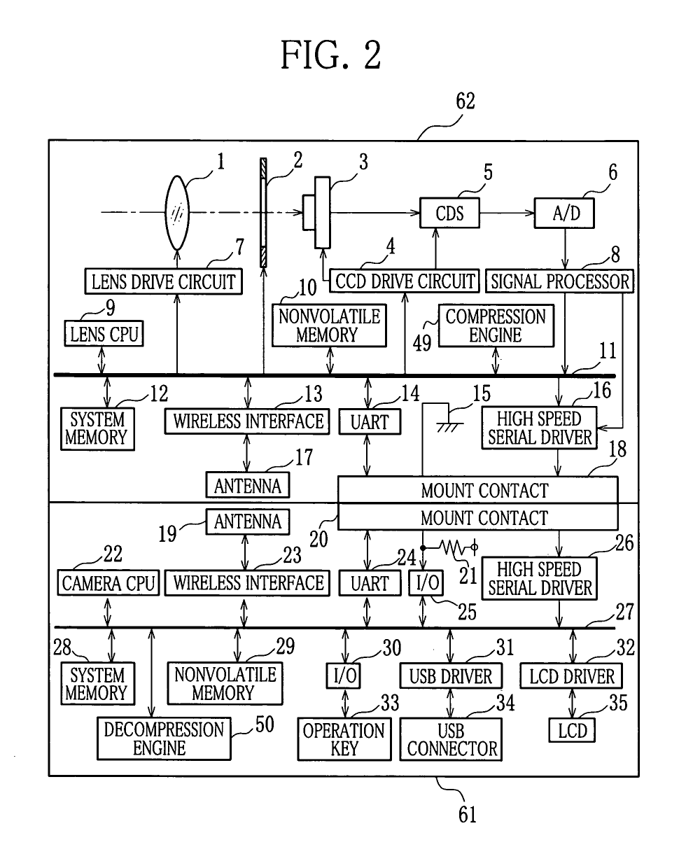

As shown in FIG. 2, the lens unit 62 has a taking lens 1, a mechanical shutter 2, a CCD image sensor 3, a correlated double sampling (CDS) circuit 5, an A/D converter 6, a signal processor 8, lens CPU 9 and so forth. Under the control of a lens drive circuit 7, the taking lens 1 moves to an in-focus position and converges light from a subject onto the CCD image sensor 3. The mechanical shutter 2 moves at a shutter timing and a shutter speed that accord to a shutter release operation. Each component of the lens unit 62 is controlled by the lens CPU 9.

The CCD image sensor 3 photoelectrically converts the subject image light converged on its light receiving surface to output image signals. The operation of the CCD image sensor 3 is controlled by transfer pulses from a CCD drive circuit 4. Incidentally, it is possible to use a CMOS type image sensor instead of the CCD image sensor 3.

The CDS circuit 5 is a noise reduction circuit, and controlled by the transfer pulses from the CCD drive circuit 4. The CDS circuit 5 eliminates noises from the image signals, which are then converted by the A/D converter 6 into digital equivalents and undergo various signal processing in the signal processor 8 to become image data.

When the lens unit 62 is attached to the camera body 61, the image data is transmitted from a high speed serial driver 16 to the camera body 61 by way of mount contacts 18, 20. The high speed serial driver 16 is a transmitter operating on a low voltage differential signaling (LVDS) technology, and able to transmit the image data at high speed through two to four signal lines. An equivalent receiver, a high speed serial driver 26 is provided in the camera body 61. It should be noted that the high speed serial transmission is made in one direction to the camera body 61 in this embodiment. Since this configuration eliminates the need for another pair of high speed serial drivers to send the data in the opposite direction, production cost of the camera system can be reduced. This is also advantageous in holding down the drive voltage of the drivers compared to the bidirectional data transmission.

When the lens unit 62 is detached from the camera body 61, the image data is firstly compressed in, for example, the JPEG format by a compression processor 49. This compressed image data transmitted wirelessly from a wireless interface 13 to the camera body 61 by way of the lens unit antenna 17. The camera body 61 receives the image data with a wireless interface 23 and decompresses the data in an decompression processor 50. This wireless transmission is by far slower than the above high speed serial transmission, and requires the image data to be compressed in order to secure a certain frame rate (frame/sec), i.e., number of frames for a through image per unit time, or to prevent an increase of the photographing interval. Incidentally, the antennas of this embodiment operate at 2.4 GHz band received by a camera CPU 22 of the camera body 61, The image data, received by a camera CPU 22 of the camera body 61, is reproduced and displayed through an LCD driver 32 on an LCD 35 if it is for a through image. Alternatively, if it is for a captured image, the image data is written to a recording medium, such as a compact flash card (not shown).

When the lens unit 62 is attached, data for system control and paring of the camera body 61 and the lens unit 62 is transmitted serially at low speed by way of universal asynchronous receiver transmitters (UART) 14, 24. In this state, a release signal or signal that requires immediate reaction is transmitted on a separate signal line (not shown) and served by the lens CPU 9 prior to a currently running process (i.e., causing an interrupt). On the contrary, when the lens unit 62 is detached, all the data and signals are transmitted by wireless.

Provided at a contact point of the camera body 61 and the lens unit 62 are detection terminals (not shown) for detecting the attachment of the lens unit 62. These detection terminals make a contact to each other when the lens unit 62 is rotated on the mount 65 which is a bayonet socket. In FIG. 2, where the lens unit 62 is attached to the camera body 61, the camera CPU 22 senses the detection terminals as a low level signal grounded by a pull down resistor 15 in the lens unit 62. When the lens unit 62 is detached from the camera body 61, by contrast, the camera CPU 22 senses the detection terminals as a high level signal because of a pull up resistor 21 in the camera body 61. Owing to these different level signals, the camera body 61 is able to detect the attachment and detachment of the lens unit 62.

The lens unit 62 and the camera body 61 have their own nonvolatile memories 10, 29 respectively to store parameters such as IDs of the lens unit 62 and the camera body 61 and an authentication code. Additionally, the nonvolatile memories 10, 29 store the names of the lens unit 62 and the camera body 61, which are set to default values (or default names) initially. These parameters are retrieved or written by the lens CPU 9 and the camera CPU 22 in a pairing process or authentication process.

Additionally, the lens CPU 9 is connected to a system memory (RAM) 12 through a CPU bus 11, and the camera CPU 22 is connected to a system memory (RAM) 28 through a CPU bus 27.

An operation key 33 is used to work on a setup screen and images displayed on the LCD 35. Commands from the operation key 33 go through an I/O port 30 to the camera CPU 22.

A USB driver 31 and the USB connector 34 allow connection of the camera system 60 to the external computer 67. The information in the nonvolatile memory 29 of the camera body 61 or the nonvolatile memory 10 of the lens unit 62 is thereby changed through the computer 67.

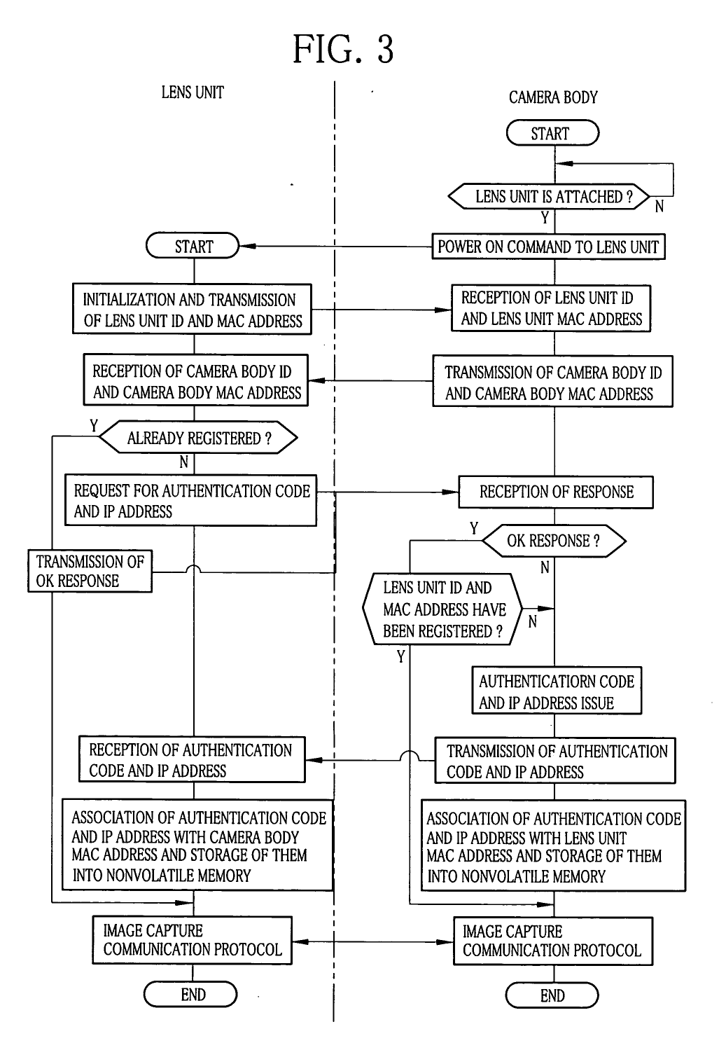

Next, the pairing process of the camera body 61 and the lens unit 62 is explained with reference to a flowchart of FIG. 3. When the power is turned on, the camera body 61 detects whether the lens unit 62 is attached thereto or not. Then the camera body 61 commands the lens unit 62, if attached, to turn on the power. In response to the command, the lens unit 62 turns on by the electric power of a built-in battery (not shown). The lens CPU 9 of the lens unit 62 firstly initializes the system memory 12, then retrieves the ID and a MAC address of the lens unit 62 from the nonvolatile memory 10 and sends them to the camera CPU 22 of the camera body 61. Upon the reception of the ID and the MAC address of the lens unit 62, the camera CPU 22 sends back the ID and a MAC address of the camera body 61 to the lens CPU 9. The lens CPU 9 searches the nonvolatile memory 10 for the ID and the MAC address of the camera body 61 identical to those just received. The lens CPU 9 sends an OK response to the camera CPU 22 if the identical ID and the MAC address are found.

Receiving the OK response, the camera CPU 22 searches the nonvolatile memory 29 for the ID and the MAC address of the lens unit 62. If found, the camera CPU 22 proceeds to an image capture communication protocol.

By contrast, if the ID and the MAC address of the camera body 61 are not found in the nonvolatile memory 10 of the lens unit 62, the lens CPU 9 makes a request to the camera body 61 for an authentication code and an IP address. In response, the camera CPU 22 issues and sends the authentication code and a unique IP address to the lens unit 62. The camera CPU 22 also associates these authentication code and IP address with the MAC address of the lens unit 62 and stores them in the nonvolatile memory 29. The lens CPU 9 stores the authentication code and IP address in the nonvolatile memory 10 in association with the MAC address of the camera body 61, and proceeds to an image capture communication protocol. In FIG. 3, all the communication between the camera body 61 and the lens unit 62 is made through the UART 14, 24.

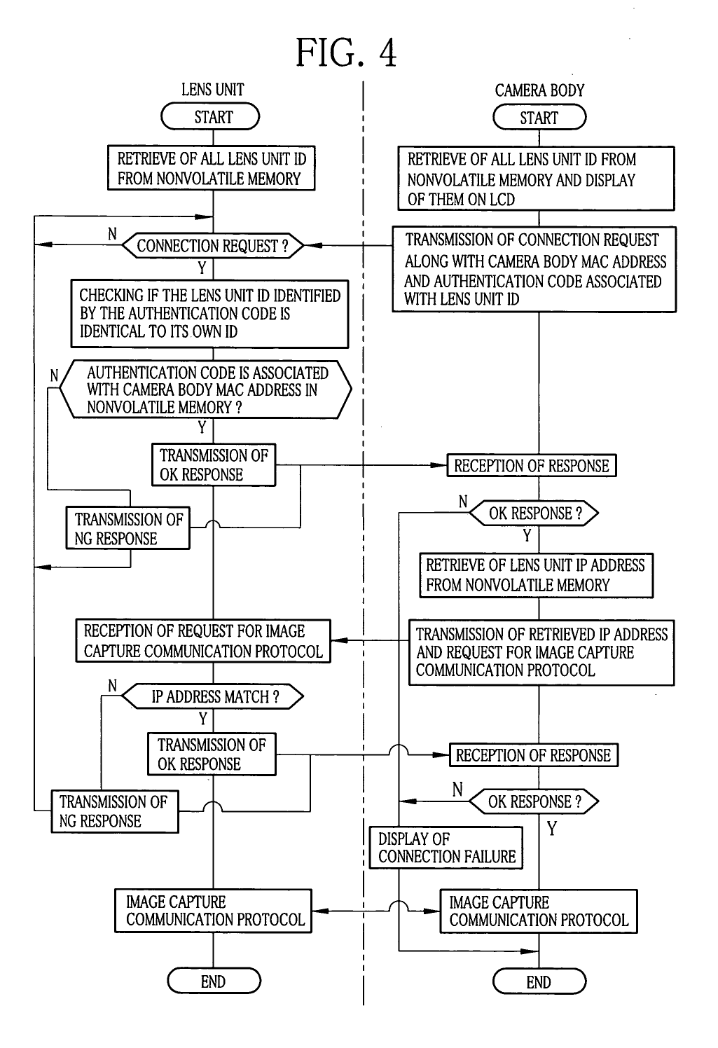

Next, an authentication process of the lens unit 62 is explained with reference to a flowchart of FIG. 4. It is to be understood that all the communication between the camera body 61 and the lens unit 62 is made through the wireless communication interfaces 13, 23 and the antennas 17, 19 in FIG. 4. After the initialization process in the startup routine, the camera body 61 retrieves all the lens unit IDs from the nonvolatile memory 29 and displays them on the LCD 35. When one of the lens unit IDs is selected through the operation key 33, the camera CPU 22 sends the authentication code that has been associated with the selected lens unit ID and the MAC address of the camera body 61, along with a connection request to the lens unit 62.

The lens unit 62 looks over the data in the nonvolatile memory 10 if the lens unit ID identified by the authentication code just received is identical to its own ID. If the MAC address of the camera body 61 and the authentication code are associated with each other and stored in the nonvolatile memory 10, the lens CPU 9 sends the OK response to the camera CPU 22. If the MC address is not stored, on the contrary, the lens CPU 9 sends an NG response to the camera CPU 22 and waits for another communication request.

When receiving the NG response, the camera CPU 22 displays a connection failure message on the LCD 35.

When receiving the OK response, the camera CPU 22 retrieves the IP address of the lens unit 62 from the nonvolatile memory 29 and sends the IP address along with a request for the image capture protocol to the lens unit 62. The lens CPU 9 determines whether the IP address sent along with the request is identical to the IP address stored with the MAC address of the camera body 61 in the nonvolatile memory 10. If the two are identical, the lens CPU 9 sends the OK response to the camera body 61 and starts the image capture communication protocol. If there is no IP address identical, on the other hand, the lens CPU 9 sends the NG response and waits for another communication request.

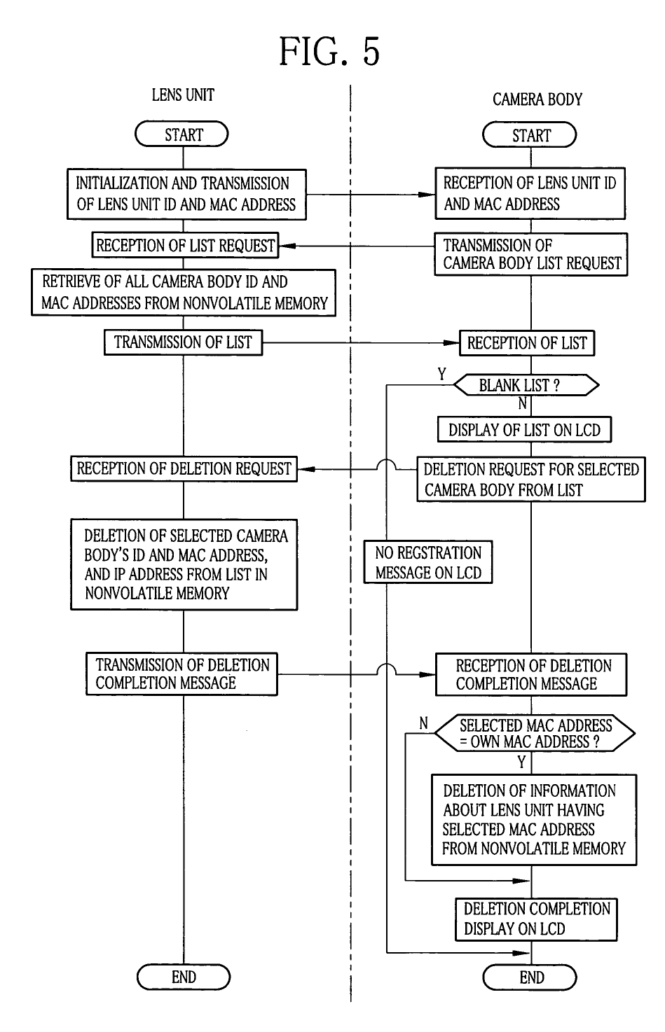

Next, a deletion process of the camera body information from the lens unit 62 is explained with reference to a flowchart of FIG. 5. When the lens unit 62 is attached to the camera body 61 and a setup mode is selected by a mode dial (not shown), the camera CPU 22 asks the lens CPU 9 for a list of camera bodies. In response, the lens CPU 9 retrieves all the IDs and MAC addresses of the camera bodies stored in the nonvolatile memory 10 and sends them to the camera CPU 22.

If there is no data in the nonvolatile memory 10, the lens CPU 9 sends a blank list. The camera CPU 22, when receiving the blank list, displays an message on the LCD 35 that there is no camera body information stored in the lens unit 62, and terminates the process.

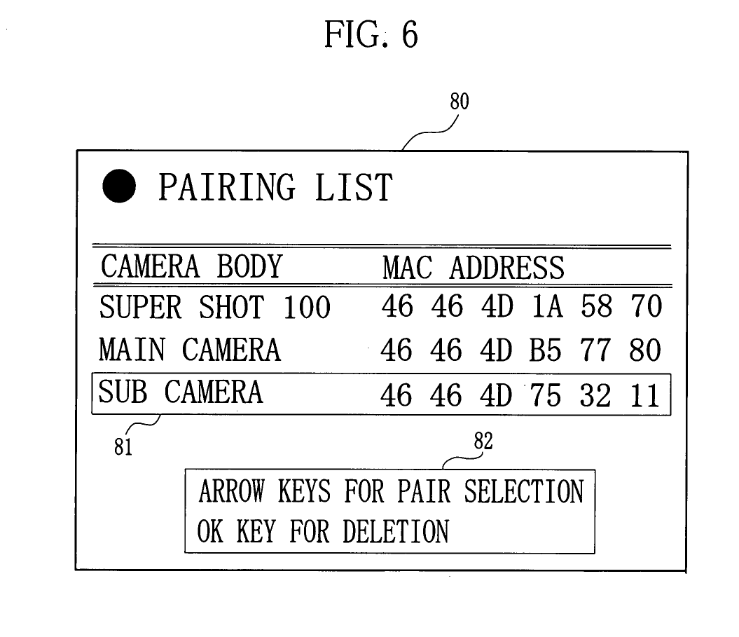

As shown in FIG. 6, the camera CPU 22 displays a pairing list screen 80 on the LCD 35, based on the received list. The user moves a cursor 81 on the screen through the operation key 33 to select a camera body to be deleted. Since an operation procedure 82 is shown in the screen at this time, the user does not have to refer to the operation manual. It is to be noted that the screen may be scrolled if the list has too many camera bodies to be displayed at once.

The camera CPU 22 directs the lens CPU 9 to delete the data of the selected camera body. The lens CPU 9 deletes the ID and the MAC address of the selected camera body together with the IP address from the nonvolatile memory 10, and sends a deletion completion message to the camera CPU 22.

When receiving the deletion completion message, the camera body 61 determines whether the deleted camera body has the MAC address identical to its own MAC address. If the two are identical, the camera CPU 22 deletes the MAC address of the lens unit 62 from the nonvolatile memory 29. Since the information about the lens unit 62 that does not need the pairing is deleted in this manner, the capacity of the nonvolatile memory can be conserved. When these sequence of the deletion process is finished, the deletion completion message is displayed on the LCD 35. Although the communication between the camera body 61 and the lens unit 62 is made through the UART 14, 24 in FIG. 5, it can be made wirelessly.

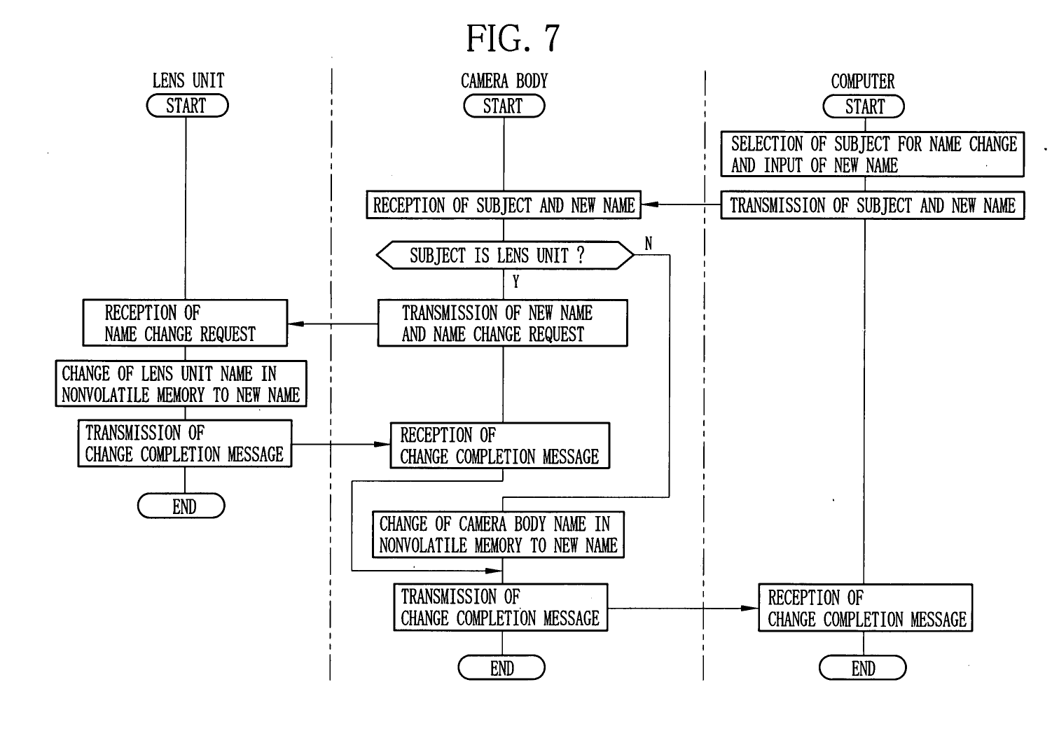

In the above embodiment, the camera body 61 and the lens unit 62 are displayed by initial names that are stored to the nonvolatile memories 10, 29 in the factory. These initial names may however be changed afterward by the user. As shown in FIG. 7, the camera body 61 is connected to the lens unit 62 and the computer 67 for a name change operation.

The user selects the subject for name change and enters a new name on the computer 67 that runs a dedicated software, and this information is sent to the camera body 61 through the USB connector. If the subject is the camera body 61, the camera CPU 22 changes the initial name in the nonvolatile memory 29 to the new name and sends a change completion message to the computer 67. If the subject is the lens unit 62, on the other hand, the camera CPU 22 sends the new name along with a name change request to the lens CPU 9.

Receiving the name change request, the lens CPU 9 changes the initial name in the nonvolatile memory 10 to the new name and sends the change completion message to the camera body 61. The camera body 61 transfers this change completion message to the computer 67, and the name change process is completed.

As described above, the user is able to give any names to the camera body 61 and the lens unit 62, and makes them easily identifiable. Additionally, the new name is displayed on the paring list 80, and this prevents the user from deleting an unintended camera body 61 or lens unit 62 in the deletion process.

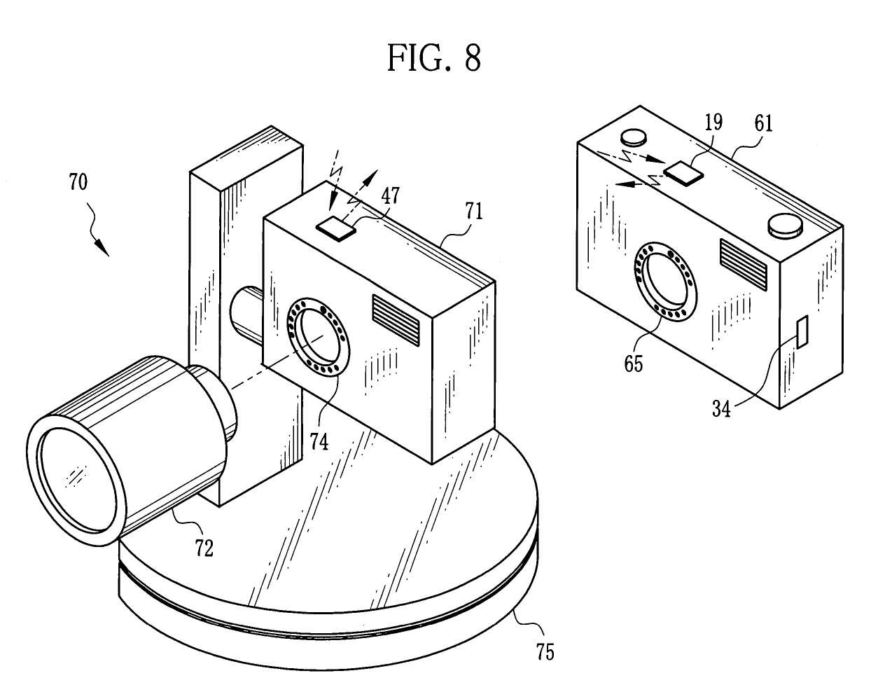

Although the antenna 17 and the wireless communication interface 23 are provided in the lens unit 62 in the above embodiment, these wireless communication components may be provided in a lens unit platform as shown in FIG. 8. In FIG.8, a camera system 70 is composed of the camera body 61 (see, FIG. 1), a lens unit 72, and an electrical platform 75 for the lens unit 72. The electrical platform 75 has a wireless communication adapter 71 and an antenna 47. Provided on the front face of the wireless communication adapter 71 is a mount 74 that connects to the lens unit 72 electrically. The lens unit 72 is attached detachably to the camera body 61 and the wireless communication adapter 71. In addition, the electrical platform 75 has a built-in actuator (not shown) which moves the wireless communication adapter 71 up, down, left, and right under a wireless control of the camera body 61. Thus, the user can change the orientation of the lens unit 72 from a distance. It should be understood that the camera body 61 is identical as in FIG. 1 and the detailed explanation thereof is omitted. In addition, the lens unit 72 is identical to the lens unit 62 except that it does not have the antenna 17, the wireless interface 23, and the compression processor 49.

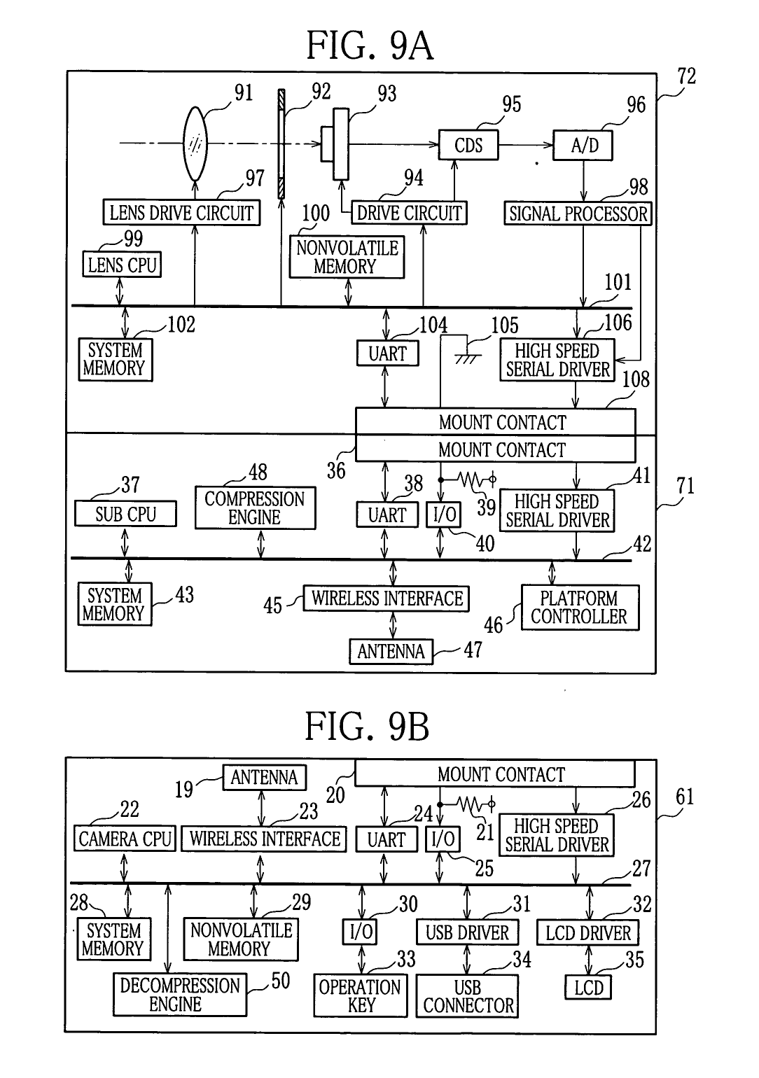

As shown in FIG. 9A and FIG. 9B, the camera CPU 22 of the camera body 61 makes wireless communication with a sub CPU 37 of the wireless communication adapter 71 through the antennas 19, 47 and the wireless interfaces 23, 45. It is therefore possible to control the electrical platform 75, and thus the attached lens unit 72, by the camera body 61 when the lens unit 72 is attached to the wireless communication adapter 71.

The wireless communication adapter 71 is connected to the lens unit 72 through mount contacts 36, 108. The sub CPU 37 and a lens CPU 99 of the lens unit 72 send and receive the signals for control by way of UART 38, 104 while transmitting the image data by way of high speed serial drivers 41, 106. The image data from the lens unit 72 is compressed in the JPEG format by the compression processor 48 of the wireless communication adapter 71 and sent to the camera body 61. The sub CPU 37 also directs a platform controller 46 to activate the actuator of the electrical platform 75 in response to a platform control command, so that the lens unit 72 changes its orientation. Incidentally, the sub CPU 37 and the lens CPU 99 are connected to system memories 43, 102 (both RAM) respectively through CPU buses 42, 101.

A pull down resister 105 is connected to the mount contact 108 of the lens unit 72, and a pull up resister 39 is connected to the mount contact 36 of the wireless communication adapter 71. The sub CPU 37 is therefore able to detect whether the lens unit 72 is attached to the wireless communication adapter 71 or not in the same manner as the camera body 61.

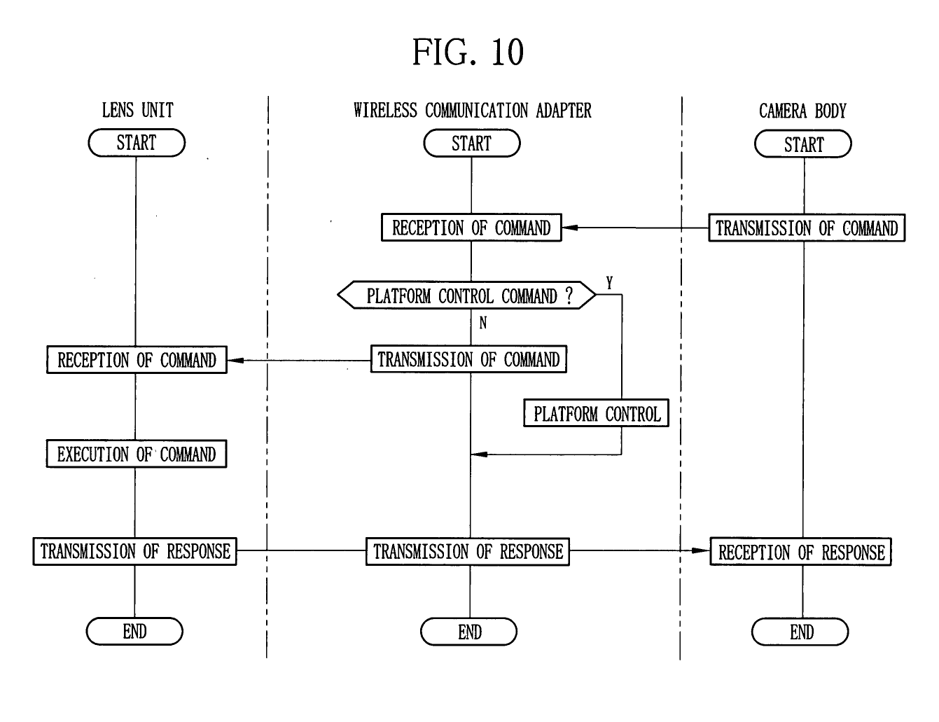

Next, the operation of the camera system 70 is explained. Since the pairing process of the lens unit 72 and the camera body 61 is identical to the above embodiment, the detailed explanation thereof is omitted. As shown in FIG. 10, the wireless communication adapter 71 checks every command from the camera body 61 to determine whether it is the platform control command. If it is so, the wireless communication adapter 71 directs the platform controller 46 to follow the command. If it is not, the wireless communication adapter 71 transfers the command to the lens unit 72 through the UART 38, 104. The lens unit 72 handles the command and sends back a response, which is transferred by the wireless communication adapter 71 to the camera body 61.

Having such wireless communication adapter 71, the electrical platform 75 enables the user to change the orientation of the lens unit 72 in any directions from a distance, and the remote image capture operation becomes by far more convenient. Additionally, since the wireless communication function and the image data compression function are not required to the lens unit 72, production cost of the lens unit 72 can be reduced.

In the camera system 70, the wireless communication adapter 71 relays the requests and the responses between the camera body 61 and lens unit 72 for authentication. It is also preferable to give the authentication function to the wireless communication adapter 71. In this case, the wireless communication adapter 71 firstly receives the camera body ID and the authentication code from the lens unit 72.

Although the authentication code is generated for every lens unit by the camera body 61 in the above embodiments, it may be preliminarily prepared in the nonvolatile memory 29 of the camera body 61 at the factory. In this case, the camera body 61 need not associate the authentication code with the ID of every lens unit.

The communication of the camera body and the lens unit may be made under Bluetooth standard. In this case, the ID of the camera body is a BD address, and the authentication code is a PIN code.

It is also possible to make wireless LAN communication prescribed by IEEE, and use the MAC address for the camera body ID and the WEP key for the authentication code. In this case, the camera body can use the lens unit name as an ESS ID to initiate the wireless communication. Additionally, the MAC address of the lens unit may be used as the lens unit ID.

In the above embodiments, the camera body 61 communicates with a single lens unit. The camera body 61 may however make a point-to-multipoint (P to MP) communication where the camera body communicates with multiple lens units. In this case, the camera body 61 issues an unique IP address to each lens unit.

Although the authentication code is issued by the camera body 61 in the above embodiments, it may be issued by the lens unit 62 alternatively.

Still in the above embodiments, the image data is transmitted on radio waves. Instead, an infrared emitting element may be used for infrared transmission of the image data.

The above embodiments are explained with the digital camera. The present invention, however, is not limited to this but applicable to any imaging devices such as a video camera system in which an image processor and an imaging device substitute for the camera body 61 and the lens unit 62 or 72 respectively.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A camera system including a lens unit having a taking lens and a solid state imaging device, and a camera body to which said lens unit is attached detachably, said camera system executing image data transmission from said lens unit to said camera body and control signal transmission/reception between said lens unit and said camera body, said camera system comprising:
a communication terminal for electrical connection between said lens unit and said camera body;
a wireless communication interface for wireless communication between said lens unit and said camera body;
an authentication information memory provided in one of said lens unit and said camera body, said authentication information memory storing authentication information used for said wireless communication;
an authentication memory provided in the other one of said lens unit and said camera body, said authentication memory storing said authentication information received through said communication terminal;
an authenticator provided in said the other one, said authenticator comparing said authentication information in said authentication memory with said authentication information received from said one through said wireless communication for verification purpose when said lens unit is detached from said camera body;
a detector in said camera body, said detector detecting attachment and detachment of said lens unit; and
a controller for controlling said communication between said lens unit and said camera body, said controller executing said image data transmission and said control signal transmission/reception through said communication terminal when said lens unit is attached to said camera body while executing said image data transmission and said control signal transmission/reception through said wireless communication when said lens unit is detached from said camera body, said controller permitting said image data transmission through said wireless communication after said verification by said authenticator.

2. A camera system described in claim 1, wherein said one is said camera body and said the other one is said lens unit.

3. A camera system described in claim 1, wherein said one is said lens unit and said the other one is said camera body.

4. A camera system described in claim 2, wherein said authentication information includes camera body identification information that identifies said camera body and an authentication code for establishment of said wireless communication, and wherein said camera body identification information and said authentication code are associated with each other in said authentication memory.

5. A camera system described in claim 2, wherein said authentication information includes camera body identification information that identifies said camera body, an authentication code for establishment of said wireless communication, and an unique IP address given to said lens unit, and wherein said camera body identification information, said authentication code, and said IP address are associated with each other in said authentication memory.

6. A camera system described in claim 3, wherein said authentication information includes lens unit identification information that identifies said lens unit and an authentication code for establishment of said wireless communication, and wherein said lens unit identification information and said authentication code are associated with each other in said authentication memory.

7. A camera system described in claim 3, wherein said authentication information includes lens unit identification information that identifies said lens unit, an authentication code for establishment of said wireless communication, and an unique IP address given to said lens unit, and wherein said lens unit identification information, said authentication code, and said IP address are associated with each other in said authentication memory.

8. A camera system described in claim 1, wherein said authentication information memory and said authentication memory are nonvolatile.

9. A camera system described in claim 1, wherein said camera body further including:
a display for showing a list of said authentication information in said authentication memory; and
an operation key for selecting said authentication information in said list, said selected authentication information being deleted from said authentication memory.

10. A camera system described in claim 9, wherein said authentication information selected by said operation key is deleted from said authentication information memory.

11. A camera system described in claim 2, wherein said lens unit further including:
a lens unit memory previously storing lens unit identification information that identifies said lens unit and a lens unit name, said lens unit identification information and said lens unit name being transmitted through said communication terminal to said camera body and stored in said authentication information memory.

12. A camera system described in claim 1, wherein said camera body further including:
an external interface for connection with an external device, through which said authentication information in said authentication information memory and said authentication memory is changed.

13. A camera system described in claim 4, wherein said camera body identification information includes a name of said camera body.

14. A camera system described in claim 4, wherein said authentication code is random numbers.

15. A camera system described in claim 4, wherein said wireless communication is executed under a Bluetooth standard with the use of a BD address of said camera body as said camera body identification information and a PIN code as said authentication code.

16. A camera system described in claim 4, wherein said wireless communication is executed under a wireless LAN system with the use of a MAC address of said camera body as said camera body identification information and a WEP key as said authentication code.

17. A camera system described in claim 11, wherein said wireless communication is initiated with said lens unit name as an ESS ID.

18. A camera system described in claim 11, wherein said lens unit identification information is a MAC address of said lens unit.

19. A lens unit having a taking lens and a solid state imaging device and being attached to a camera body detachably, said lens unit transmitting image data to said camera body while transmitting/receiving control signals with said camera body, said lens unit comprising:
a communication terminal for electrical connection with said camera body;
a wireless communication interface for wireless communication with said camera body;
an authentication memory for storing authentication information received from said camera body through said communication terminal, said authentication information being used for said wireless communication;
an authenticator for comparing said authentication information in said authentication memory with said authentication information received from said camera body through said wireless communication for verification purpose when said lens unit is detached from said camera body; and
a lens controller for controlling all circuits of said lens unit, said lens controller permitting said image data transmission through said wireless communication after said verification by said authenticator.

20. A lens unit described in claim 19, wherein said authentication information includes camera body identification information that identifies said camera body and an authentication code for establishment of said wireless communication, and wherein said camera body identification information and said authentication code are associated with each other in said authentication memory.

21. A lens unit described in claim 19, wherein said authentication information includes camera body identification information that identifies said camera body, an authentication code for establishment of said wireless communication, and an unique IP address given to said lens unit, and wherein said camera body identification information, said authentication code, and said IP address are associated with each other in said authentication memory.

22. A lens unit described in claim 19, wherein said authentication memory is nonvolatile.

23. A camera body to which a lens unit having a taking lens and a solid state imaging device is attached detachably, said camera body receiving image data from said lens unit and transmitting/receiving control signals with said lens unit, said camera body comprising:
a communication terminal for electrical connection with said lens unit;
a wireless communication interface for wireless communication with said lens unit;
an authentication information memory for storing authentication information used for said wireless communication, said authentication information being transmitted to said lens unit through said communication terminal and stored to an authentication memory in said lens unit;
a detector for detecting attachment and detachment of said lens unit; and
a camera controller for controlling all circuits of said camera body, said camera controller executing said image data transmission and said control signal transmission/reception through said communication terminal when said lens unit is attached to said camera body while executing said image data transmission and said control signal transmission/reception through said wireless communication when said lens unit is detached from said camera body.

24. A camera body described in claim 23, wherein said authentication information includes camera body identification information that identifies said camera body and an authentication code for establishment of said wireless communication, and wherein said camera body identification information and said authentication code are associated with each other in said authentication memory.

25. A camera body described in claim 23, wherein said authentication information includes camera body identification information that identifies said camera body, an authentication code for establishment of said wireless communication, and an unique IP address given to said lens unit, and wherein said camera body identification information, said authentication code, and said IP address are associated with each other in said authentication memory.

26. A camera body described in claim 23, wherein said authentication information memory is nonvolatile.

27. A camera system including a lens unit having a taking lens and a solid state imaging device, a camera body to which said lens unit is attached detachably, and a wireless communication adapter to which said lens unit is attached detachably, said camera system executing image data transmission from said lens unit to said camera body and control signal transmission/reception between said lens unit and said camera body, said camera system comprising:
a communication terminal for electrical connection of said lens unit to said camera body and said wireless communication adapter;
a wireless communication interface for wireless communication between said camera body and said wireless communication adapter;
an authentication information memory provided in said camera body, said authentication information memory storing authentication information used for said wireless communication;
an authentication memory provided in said lens unit, said authentication memory storing said authentication information received from said camera body through said communication terminal;
an authenticator provided in said lens unit, said authenticator comparing said authentication information in said authentication memory with said authentication information received from said camera body through said wireless communication for verification purpose when said lens unit is detached from said camera body;
a detector provided in said camera body, said detector detecting attachment and detachment of said lens unit; and
a controller provided in said camera body, said controller controlling said communication between said lens unit and said camera body, said controller executing said image data transmission and said control signal transmission/reception through said communication terminal when said lens unit is attached to said camera body while executing said image data transmission and said control signal transmission/reception through said wireless communication when said lens unit is detached from said camera body, said controller permitting said image data transmission through said wireless communication after said verification by said authenticator.

28. A lens unit having a taking lens and a solid state imaging device and being attached detachably to a camera body or a wireless communication adapter which makes wireless communication with said camera body, said lens unit transmitting image data to said camera body while transmitting/receiving control signals to said camera body, said lens unit comprising:
a communication terminal for electrical connection with said camera body and said wireless communication adapter;
an authentication memory for storing authentication information received from said camera body through said wireless communication when said lens unit is attached to said camera body, said authentication information being used for said wireless communication;
an authenticator for comparing said authentication information in said authentication memory with said authentication information received from said camera body through said wireless communication for verification purpose when said lens unit is detached from said camera body; and
a lens controller for controlling all circuits of said lens unit, said lens controller permitting said image data transmission through said wireless communication after said verification by said authenticator.

29. A camera body to which a lens unit having a taking lens and a solid state imaging device is attached detachably, said camera body receiving image data from said lens unit and transmitting/receiving control signals with said lens unit, said lens unit being attached detachably to a wireless communication adapter which makes wireless communication with said camera body, said camera body comprising:
a communication terminal for electrical connection with said lens unit;
a wireless communication interface for wireless communication with said wireless communication adapter;
an authentication information memory for storing authentication information used for said wireless communication, said authentication information being transmitted to said lens unit through said communication terminal and stored to an authentication memory in said lens unit;
a detector for detecting attachment and detachment of said lens unit; and
a camera controller for controlling all circuits of said camera body, said camera controller executing said image data transmission and said control signal transmission/reception through said communication terminal when said lens unit is attached to said camera body while executing said image data transmission and said control signal transmission/reception through said wireless communication when said lens unit is detached from said camera body.

30. A wireless communication adapter to which a lens unit having a taking lens and a solid state imaging device is attached detachably, said wireless communication adapter transmitting image data to a camera body while transmitting/receiving control signals with said camera body, said wireless communication adapter comprising:
a communication terminal for electrical connection with said lens unit;
a wireless communication interface for wireless communication with said camera body;
a recognizer for recognizing a command to said lens unit received from said camera body; and
a detector for detecting attachment and detachment of said lens unit.
